(19) United States
(12) Patent Application Publication
(10) Pub. No.: US 2026/0156254 A1
(43) Pub. Date: Jun. 4, 2026

(54) IMAGE PROCESSING DEVICE, IMAGE CAPTURE DEVICE, CONTROL METHOD FOR IMAGE PROCESSING DEVICE, AND NON-TRANSITORY COMPUTER-READABLE STORAGE MEDIUM

(71) Applicant: CANON KABUSHIKI KAISHA, Tokyo (JP)

(72) Inventors: DAISUKE SAKAMOTO, Kanagawa (JP); KOJI TOGITA, Kanagawa (JP); KATSUHIKO AZUMA, Kanagawa (JP)

(21) Appl. No.: 19/399,891

(22) Filed: Nov. 25, 2025

(30) Foreign Application Priority Data
Dec. 3, 2024 (JP) 2024-210770

(51) Int. Cl. H04N 19/11; H04N 19/119; H04N 19/14; H04N 19/176; H04N 19/189

(52) U.S. Cl. CPC H04N 19/11; H04N 19/119; H04N 19/14; H04N 19/176; H04N 19/189

(57) ABSTRACT

An image processing device comprising, an encoding mode determination unit configured to determine, based on information on a first encoding mode in a first encoding scheme for an encoding-target image, a second encoding mode in a second encoding scheme different from the first encoding scheme through inference using a neural network, for the encoding-target image, and an encoding unit configured to encode the encoding-target image using the second encoding mode.

### BACKGROUND

### Field of the Technology

The present disclosure relates to an image processing device, an image capture device, a control method for an image processing device, and a non-transitory computer-readable storage medium.

### Description of the Related Art

In recent years, a plurality of next-generation video encoding schemes have been proposed, including AOMedia Video 1 (AV1) and Versatile Video Coding (VVC) (Nathan Egge, “Into the Depths: The Technical Details Behind AV1”, Mile High Video Workshop 2018 Jul. 31, 2018, [retrieved Nov. 8, 2024], <URL: http://dgql.org/˜unlord/MHV2018.pdf>, and Versatile video coding 2023 Sep. 29<URL: https://www.itu.int/rec/T-REC-H.266-202309-I/en>). AV1 is expected to be used in moving image distribution services, while VVC is expected to be used in next-generation terrestrial digital broadcasting. Since these schemes target different users, image processing devices need to be equipped with respective codecs. In this case, an ASIC equipped with codecs in the image processing device will need to be equipped with codecs that support a plurality of schemes (AV1/VVC) in addition to the conventional encoding schemes (H.264/HEVC), which may result in an enlarged circuit scale.

### SUMMARY

The present disclosure provides a technique that enables a reduction in circuit scale when making an image processing device compatible with a plurality of encoding schemes.

An exemplary embodiment relates to an image processing device comprising, an encoding mode determination unit configured to determine, based on information on a first encoding mode in a first encoding scheme for an encoding-target image, a second encoding mode in a second encoding scheme different from the first encoding scheme through inference using a neural network, for the encoding-target image, and an encoding unit configured to encode the encoding-target image using the second encoding mode.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1A is a diagram showing an example of a configuration of an image processing system according to an embodiment.

FIG. 1B is a diagram showing an example of a configuration of an image processing device according to an embodiment.

FIG. 2A is a diagram showing an example of a configuration of an image processing device according to an embodiment.

FIG. 2B is a diagram for describing an example of a configuration of an image processing device according to a first embodiment.

FIG. 3 is a flowchart showing an example of processing according to an embodiment.

FIG. 4 is a diagram for describing prediction directions in encoding schemes described in an embodiment.

FIG. 5 is an explanatory diagram showing an example of an intra prediction image generation method in an HEVC scheme.

FIG. 6A is a diagram showing an example of a functional configuration for updating inference parameters according to an embodiment.

FIG. 6B is a diagram showing another example of a functional configuration for updating inference parameters according to an embodiment.

FIG. 7A is an explanatory diagram of an example of a configuration of a neural network according to an embodiment.

FIG. 7B is a diagram showing an example of a configuration of neurons in a neural network according to an embodiment.

FIG. 8A is a diagram showing an example of block partition patterns for encoding schemes described in an embodiment.

FIG. 8B is a diagram showing an example in which partition patterns in the HEVC encoding scheme are integrated into 128×128-size units.

FIG. 8C is a diagram showing an example of a schematic configuration of an image processing device according to a second embodiment.

FIG. 8D is a flowchart showing an example of processing corresponding to the second embodiment.

FIG. 9A is an explanatory diagram comparing a block partition scheme of HEVC and a block partition scheme of VVC.

FIG. 9B is a diagram showing an example of a schematic configuration of an image processing device according to a third embodiment.

FIG. 9C is a diagram showing an example of a functional configuration for updating inference parameters corresponding to the third embodiment.

FIG. 9D is an explanatory diagram showing a relationship between an object outline and a block partition boundary according to the third embodiment.

FIG. 10A is a diagram showing an example of an encoding-target image corresponding to fourth and fifth embodiments.

FIG. 10B is a diagram showing an example of a schematic configuration of an image processing device corresponding to the fourth and fifth embodiments.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

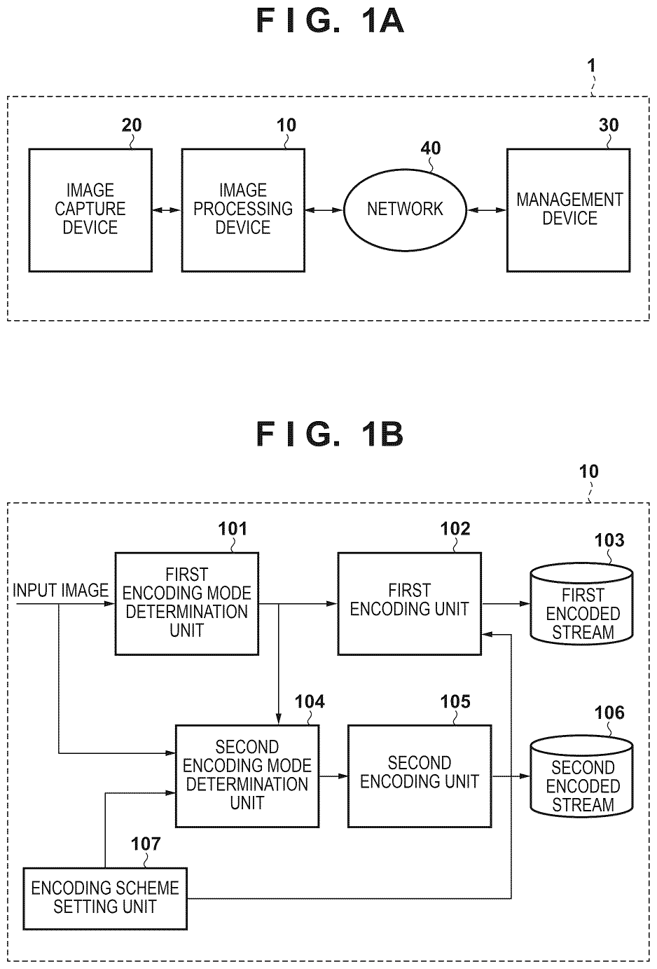

FIG. 1A shows an example of a configuration of an image processing system 1 according to this embodiment. In this embodiment, an image capture device 20 is connected to an image processing device 10, and an image captured by the image capture device 20 is processed in the image processing device 10 to generate a stream. In the image processing device 10, for example, encoding processing according to a plurality of encoding schemes described in this embodiment is carried out. The stream generated in the image processing device 10 is transmitted to an external management device 30 via a network 40. The management device 30 can execute processing such as displaying the received stream on a screen, changing the settings of the image processing device 10 according to the display content, and changing the settings of the image capture device 20, such as the image capture direction and image capture conditions. The image processing system 1 can be configured as, for example, a surveillance camera system, in which a plurality of image capture devices 20 are arranged within a surveillance target region, and surveillance images of surveillance regions for the respective image capture devices 20 can be provided to the management device 30.

In FIG. 1A, the image processing device 10 and the image capture device 20 are shown as independent devices, but they may be integrated into an image capture device.

Next, the configuration of the image processing device 10 of this embodiment will be described with reference to FIG. 1B. The image processing device 10 is configured as, for example, a device that encodes a captured image input from an image capture device 20 and outputs an encoded stream. The image processing device 10 may be realized by circuit implementation using an ASIC or FPGA, or may be constituted by a CPU, a memory that stores an execution program, and the like. The image processing device 10 includes a first encoding mode determination unit 101 for H.264 or HEVC (H.265) (hereinafter collectively referred to as “HEVC”) serving as a first encoding scheme, a first encoding unit 102, and a first encoded stream storage 103. The image processing device 10 also includes a second encoding mode determination unit 104 for AV1 or VVC serving as a second encoding scheme, a second encoding unit 105, a second encoded stream storage 106, and an encoding scheme setting unit 107.

For example, an image captured by the image capture device 20 is input to the first encoding mode determination unit 101 and the second encoding mode determination unit 104 as an encoding-target image or an input image. The first encoding mode determination unit 101 determines the encoding mode of HEVC, outputs a difference image generated according to the determined encoding mode to the first encoding unit 102, and outputs information on the determined encoding mode to the second encoding mode determination unit 104. The first encoding unit 102 performs encoding processing according to a first encoding scheme, such as integer transform, quantization, and entropy encoding, on the input difference image and stores the resulting first encoded stream in the first encoded stream storage 103.

In addition, the second encoding mode determination unit 104 determines the encoding mode of AV1/VVC by referring to the information on the encoding mode of the first encoding scheme input from the first encoding mode determination unit 101, and outputs a difference image generated in accordance with the determined encoding mode to the second encoding unit 105. The second encoding unit 105 performs encoding processing according to a second encoding scheme, such as integer transform, quantization, and entropy encoding, on the input difference image and stores the resulting second encoded stream in the second encoded stream storage 106.

If one of the encoding schemes HEVC, AV1, and VVC is selected in accordance with a designation from a user of the image processing device 10, the encoding scheme setting unit 107 transmits the designated encoding scheme to at least the first encoding unit 102 and the second encoding mode determination unit 104. The first encoding unit 102 executes the encoding processing if HEVC is designated, and the second encoding mode determination unit 104 determines the encoding mode in accordance with the designated encoding scheme. In this embodiment, if HEVC is designated, the second encoding mode determination unit 104 does not perform the second encoding mode determination processing, and the second encoding unit 105 does not perform the second encoding processing. On the other hand, even if either AV1 or VVC is designated, the first encoding mode determination unit 101 performs the first encoding mode determination processing, but the first encoding unit 102 does not perform the first encoding processing.

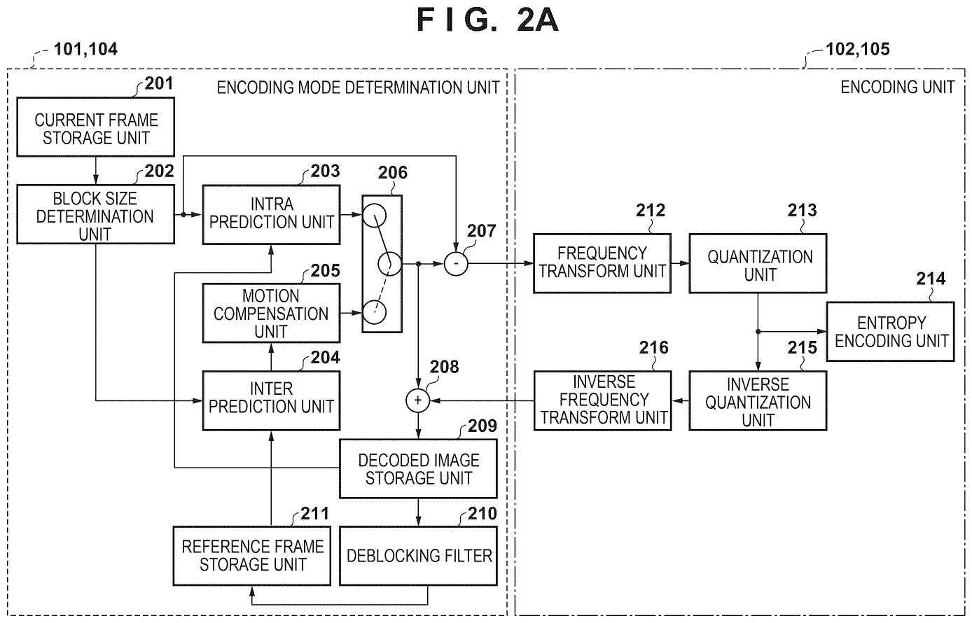

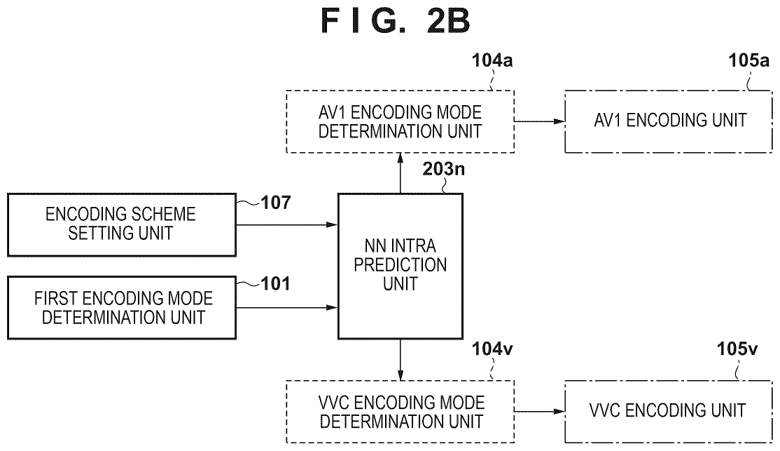

Next, with reference to FIG. 2A, an example of a functional configuration held in common by the encoding mode determination units and encoding units for HEVC, AV1, and VVC in the image processing device 10 will be described. As will be described later, one of the features of this embodiment is that part of the configuration for AV1 and VVC is made common by implementing it as a neural network, and FIG. 2A shows the basic configuration before being implemented as a neural network for the purpose of describing each encoding mode determination unit and each encoding unit. Each configuration will be described below.

A current frame storage unit 201 receives input of an encoding-target image, which has been captured by the image capture device 20, and temporarily stores this image. A block size determination unit 202 determines the encoding block size for the encoding-target image. The determined block size is output to an intra prediction unit 203 and an inter prediction unit 204. In addition, the block size determination unit 202 outputs the image of the current frame to the intra prediction unit 203, the inter prediction unit 204, and a subtractor 207.

The intra prediction unit 203 partitions the processing-target frame image into predetermined block units, predicts the image of each block based on pixels in the surrounding region of the block, and generates a predicted image. As will be described later, HEVC, AV1, and VVC have different prediction modes in intra prediction. For example, HEVC has 35 modes (33 angular prediction modes, a planar prediction mode, and a DC prediction mode), while AV1 has 60 modes (56 angular prediction modes, 3 smooth prediction modes, and a Paeth filter mode), and VVC has 81 modes (65 angular prediction modes, a planar prediction mode, a DC prediction mode, and a wide-angle prediction mode).

The inter prediction unit 204 partitions the input current frame image into predetermined block units, and in each block, performs motion search processing for detecting a position with high correlation with a reference frame image stored in a reference frame storage unit 211, and detects difference data at that position as motion information between frames. The prediction accuracy of inter prediction also differs depending on the method, and HEVC has ¼ pixel accuracy for a luminance signal, while AV1 has ⅛ pixel accuracy and VVC has 1/16 pixel accuracy.

A motion compensation unit 205 performs motion compensation to generate a predicted image of the current frame image from the reference frame image and motion information. A motion compensation algorithm also differs depending on the scheme, and HEVC uses a motion compensation interpolation filter set for motion vector search, whereas VVC uses a motion compensation interpolation filter set that uses affine transformation in addition to the motion compensation interpolation filter set. AV1 uses five types of motion compensation interpolation filters. A switch unit 206 is a switching mechanism that selects either predicted image output from the intra prediction unit 203 or predicted image output from the motion compensation unit 205. The output from the switch unit 206 is output to the subtractor 207 and an adder 208.

The subtractor 207 outputs a difference image obtained by subtracting the predicted image from the current frame image to a frequency transform unit 212. The adder 208 adds the predicted image and the decoded result of the difference image output from an inverse frequency transform unit 216 to generate a decoded image. The decoded image is stored in a decoded image storage unit 209 and output to the intra prediction unit 203 and a deblocking filter 210. The deblocking filter 210 executes deblocking filter processing for correcting discontinuity in boundary data in predetermined block units. The result of the deblocking filter processing is output to the reference frame storage unit 211 and stored as a reference frame in the inter prediction unit 204.

The frequency transform unit 212 performs integer transform on the difference image provided by the subtractor 207 and outputs the processing result to a quantization unit 213. The integer transform processing here also differs depending on the method, with HEVC using DCT (discrete cosine transform) 2 and supporting only square blocks. On the other hand, AV1 uses DCT, asymmetric discrete sine transform (ADST), inverse asymmetric discrete sine transform (inverse ADST), and identity transform, and supports not only square but also rectangular blocks (4×8 pixels, 8×16 pixels, etc.). VVC controls switching between a plurality of orthogonal transforms such as DCT2, DCT8, and DST7, and supports both square and rectangular blocks.

The quantization unit 213 performs quantization processing on transform coefficients obtained through the integer transform using a predetermined quantization scale. An entropy encoding unit 214 performs entropy encoding processing on the quantized transform coefficients to perform data compression. The processing details here also differ depending on the scheme. HEVC uses context-adaptive binary arithmetic coding (CABAC), while AV1 uses adaptive multi-symbol arithmetic coding (AMSAC), and VVC uses CABAC as well as adaptive quantization of transform coefficients. The quantization result is output also to an inverse quantization unit 215, which executes predetermined inverse quantization processing on the quantized transform coefficients and outputs the result to the inverse frequency transform unit 216. The inverse frequency transform unit 216 executes an inverse integer transform for returning the inverse-quantized transform coefficients to the original image data space, and outputs the difference image obtained as a result of the transform to the adder 208.

Although the above is an example of a configuration of the image processing device 10 held in common for HEVC, AV1, and VVC, as described above, the technical content to be implemented in each functional block differs, and therefore configurations corresponding to the respective encoding schemes must be prepared. The configuration shown in FIG. 2A is generally implemented in an ASIC, but providing an image processing device for each encoding scheme inevitably increases the circuit scale. In view of this, this embodiment uses a circuit configuration that enables the second encoding mode to be determined through inference based on the encoding mode in the first encoding scheme determined by the first encoding mode determination unit 101, thereby making it possible to reduce the circuit scale.

Specifically, an example of the configuration of the image processing device 10 for reducing the circuit scale in this embodiment will be described with reference to FIG. 2B. FIG. 2B illustrates a configuration in which the intra prediction unit 203 is shared between an encoding mode determination unit 104a for AV1 and an encoding mode determination unit 104v for VVC included in the second encoding mode determination unit 104. FIG. 2B shows a configuration in which the intra prediction unit 203 of the encoding mode determination unit 104v for VVC is replaced with a neural network (NN) intra prediction unit 203n, which is shared with the intra prediction unit of the encoding mode determination unit 104a for AV1. Hereinafter, among the functional blocks in FIG. 2A, those with an “a” in their reference numbers are for AV1, those with a “v” in their reference numbers are for VVC, and those with an “h” in their reference numbers are for HEVC. In addition, the reference numbers of functional blocks that have been implemented as neural networks and shared will include “n”.

In the configuration of FIG. 2B, the NN intra prediction unit 203n receives input of a signal indicating which encoding scheme has been selected from HEVC, AV1, and VVC, from the encoding scheme setting unit 107. If the VVC encoding scheme has been selected, the NN intra prediction unit 203n operates as an NN intra prediction unit in the VVC encoding mode determination unit 104v. The NN intra prediction unit 203n acquires the result of the intra prediction for HEVC in the first encoding mode determination unit 101 and the encoding-target image from the first encoding mode determination unit 101, and performs intra prediction for VVC through inference using intra prediction and the encoding-target image.

On the other hand, if the AV1 encoding scheme has been selected, the NN intra prediction unit 203n operates as an NN intra prediction unit in the AV1 encoding mode determination unit 104a. The NN intra prediction unit 203n acquires the result of intra prediction for HEVC in the first encoding mode determination unit 101 and the encoding-target image from the first encoding mode determination unit 101, and performs intra prediction for AV1 through inference using the intra prediction and the encoding-target image.

If HEVC has been selected in the encoding scheme setting unit 107, only encoding using the first encoding scheme is performed, and encoding using AV1 and HEVC is not performed. Accordingly, if it is detected that HEVC has been selected in the NN intra prediction unit 203n, the operations of the encoding mode determination units for AV1 and VVC are stopped. This makes it possible to omit unnecessary encoding processing and suppress power consumption.

By adopting the configuration of FIG. 2B, the intra prediction unit 203 is removed from the encoding mode determination unit 104a for AV1 and the encoding mode determination unit 104v for VVC and is shared. In this way, the more modes that can be predicted using inference by a neural network, the more the circuit scale can be reduced. In FIG. 2B, only the intra prediction unit 203 is shared, but the block size determination unit 202 and the inter prediction unit 204 may also be implemented as neural networks and shared.

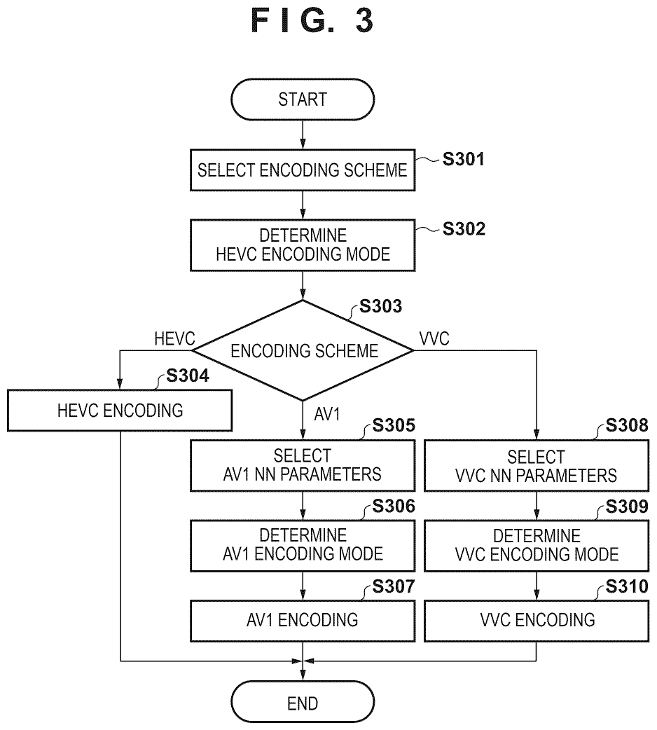

Next, an example of encoding processing corresponding to this embodiment, which is performed based on the configurations of FIGS. 2A and 2B, will be described. FIG. 3 is a flowchart showing an example of processing corresponding to this embodiment.

First, in step S301, the encoding scheme setting unit 107 accepts the selection of an encoding scheme. In this embodiment, the encoding scheme is selected from HEVC, AV1, and VVC. In the subsequent step S302, the first encoding mode determination unit 101 performs processing for determining the encoding mode in the HEVC encoding scheme. The information on the encoding mode determined here includes, for example, information on the block size, intra prediction mode, block partitioning for inter prediction, and the like. In the subsequent step S303, the encoding scheme accepted in step S301 is determined, and the processing proceeds to step S304 if it is HEVC, the processing proceeds to step S305 if it is AV1, and the processing proceeds to step S308 if it is VVC.

In step S304, the first encoding unit 102 performs encoding processing in HEVC. On the other hand, in step S305, the encoding mode determination unit 104a for AV1 of the second encoding mode determination unit 104 selects NN parameters (inference parameters) for AV1, and in step S306, executes processing for determining the AV1 encoding mode. For example, in the case of the configuration of FIG. 2B, the processing includes performing AV1 intra prediction through inference using inference parameters for AV1 in the NN intra prediction unit 203n, and performing inter prediction, with reference to the encoding mode determined in HEVC encoding. In the subsequent step S307, the AV1 encoding unit 105a of the second encoding unit 105 performs encoding processing on a difference image obtained by subtracting a predicted image generated in the determined encoding mode from a frame image.

In step S308, the encoding mode determination unit 104v for VVC in the second encoding mode determination unit 104 selects NN parameters (inference parameters) for VVC, and in step S309, executes processing for determining the VVC encoding mode. For example, in the case of the configuration of FIG. 2B, the processing includes performing VVC intra prediction through inference using inference parameters for VVC in the NN intra prediction unit 203n, and performing inter prediction, with reference to the encoding mode determined in HEVC encoding. In the subsequent step S310, the VVC encoding unit 105v of the second encoding unit 105 performs encoding processing on a difference image obtained by subtracting a predicted image generated in the determined encoding mode from a frame image.

As described above, in this embodiment, the encoding mode in the second encoding scheme is determined by performing inference using a neural network based on the encoding mode determined for the first encoding scheme. This utilizes the correlation between the first encoding mode and the second encoding mode, and the relationship between the two will be described below.

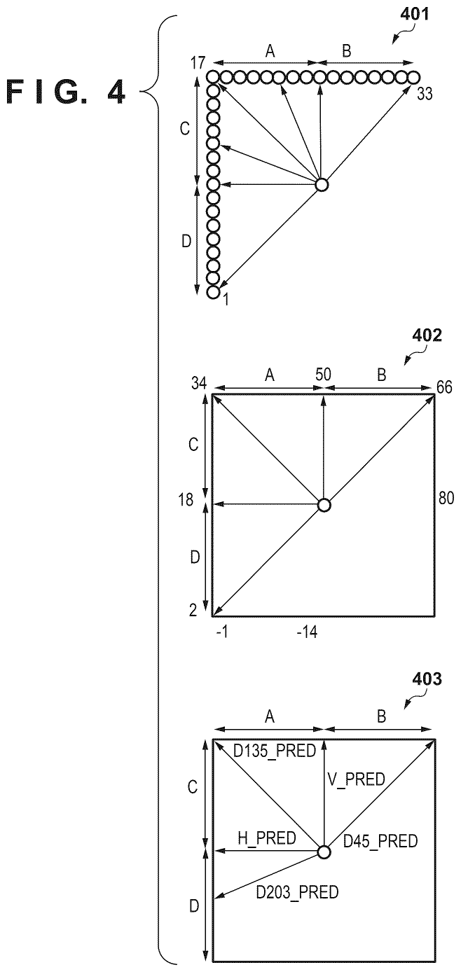

In the following, the intra prediction mode among the encoding modes will be described as an example. Intra prediction in HEVC includes 33 angular prediction modes, a DC prediction mode, and a planar prediction mode, as shown in a prediction pattern 401 in FIG. 4. Angular prediction is a mode that performs directional interpolation prediction from neighboring pixels, and prediction can be performed in any of 33 modes. In this case, the 33 modes can be divided into four groups labeled A to D. That is, modes 1 to 9 are group D, modes 9 to 17 are group C, modes 17 to 26 are group A, and modes 26 to 33 are group B.

In contrast, in intra prediction for VVC, as shown in a prediction pattern 402, there are a DC prediction mode and a planar prediction mode in addition to 65 angular prediction modes. There are 65 modes for angular prediction, which is almost double the number of modes in HEVC (33 modes). In VVC as well, modes can also be divided into four groups so as to correspond to groups A to D of HEVC. Accordingly, if group A is predicted in HEVC, there is a high likelihood that prediction will be made in the direction of the corresponding group A in VVC as well. Note that in VVC, there are prediction modes called Wide Angle prediction, which are modes −1 to −14 and 67 to 80, in which it is possible to perform angular prediction that exceeds the maximum angle of angular prediction that can be selected only for non-square prediction blocks.

In addition, in intra prediction for AV1, as shown in a prediction pattern 403, there are 56 angular prediction modes, as well as 3 smooth prediction modes and Paeth prediction modes. There are 56 angular prediction modes, which is not as many as in VVC, but is nearly double the 33 modes in HEVC. In AV1 as well, modes can also be divided into four groups so as to correspond to groups A to D in HEVC. Accordingly, when prediction is made in group A in HEVC, there is a high likelihood that prediction will be made in the direction of the corresponding group A in AV1 as well.

In this way, by applying an NN to perform inference based on the angular prediction mode (first prediction direction) in the intra prediction mode in the HEVC format, it is possible to efficiently determine the angular prediction mode (second prediction direction) in VVC or AV1 as well. In addition, the angular prediction mode of the HEVC method determined for the same encoding-target image is highly correlated with the angular prediction modes for AV1 and VVC, and therefore using this as input is expected to simplify the structure of the NN. On the other hand, in inference using a NN, the angular prediction mode determined in the HEVC method is not necessarily adopted as-is, and therefore it is possible to avoid narrowing down the angular prediction modes to group A in the AV1 and VVC methods. For example, even if a mode of group A is selected in HEVC, if the selected mode is located on the boundary between group A and group B, or on the boundary between group A and group C, group A will not necessarily be selected in VVC or AV1, and group B or group C may be selected instead. Inference using an NN can handle such a case as well.

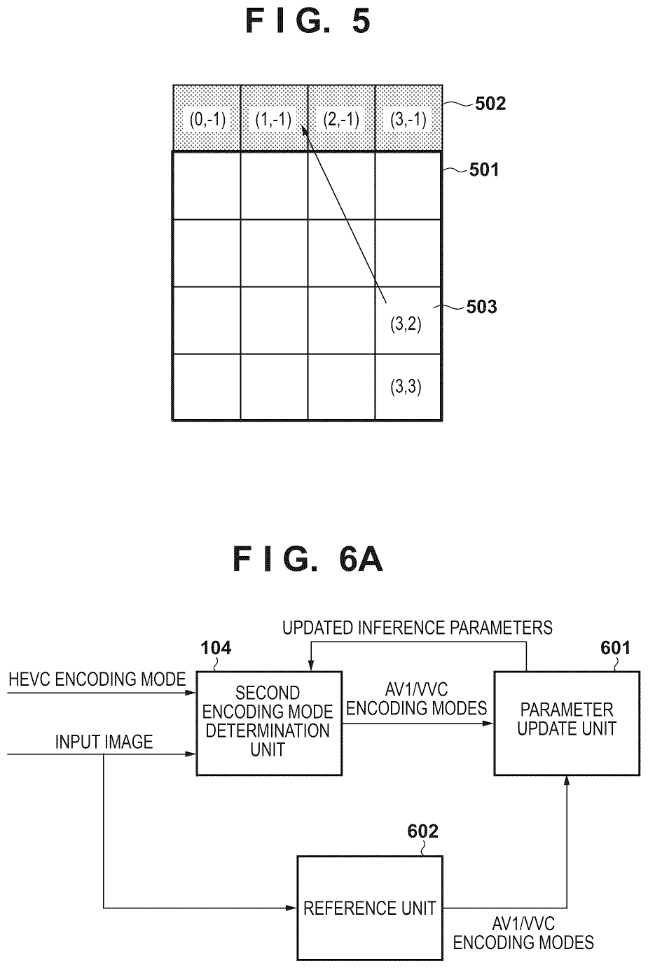

Next, a specific example of a method for generating intra prediction images in the HEVC scheme will be described with reference to FIG. 5. FIG. 5 shows an example of intra prediction in which a prediction image is generated for a 4×4-pixel block image 501 based on surrounding reference images 502. Here, a case will be described in which a predicted image of a pixel 503 at the position of coordinates (3, 2) in the block image 501 is obtained.

For example, if the direction indicated by the arrow from pixel 503 is the mode 22, the slope of the reference direction is 13/32, and therefore if movement is performed by −3 in the y direction (vertical direction) to a position on the reference image 502, a shift by 13/32×3=39/32 occurs in the x direction (horizontal direction). That is, (3−39/32)=57/32, and from that, (57/32,−1) is set as the predicted image, but since there is no pixel at the 57/32 position, the pixel at a position shifted 25/32 from (1,−1) and 7/32 from (2,−1) is calculated using a ratio. Accordingly, (7×pixel value of (1,−1)+25×pixel value of (2,−1))/32 is calculated.

In this way, depending on the selected intra prediction mode, it is necessary to add adjacent reference images according to a ratio to obtain the predicted image. In this case, the number of modes in VVC and AV1 is nearly twice as large, making it possible to generate predicted images with higher accuracy than in HEVC. Also, depending on the selected mode, there may be cases where it is not necessary to add up reference pixels according to the ratio. For example, the number of modes in VVC is twice that of prediction modes in HEVC, and even if a desired pixel position cannot be selected in HEVC, there may be cases where it is possible to select a mode in which the desired pixel position is directly designated in VVC.

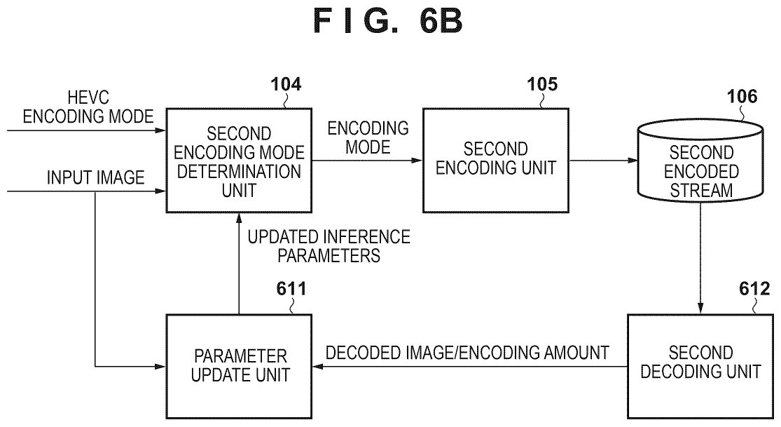

Next, the inference parameters of the neural network (NN) in the encoding mode determination units for AV1 and VVC in this embodiment will be described. First, an example of a method for learning inference parameters according to this embodiment will be described with reference to FIGS. 6A and 6B. FIG. 6A is a diagram illustrating an example of a functional configuration for updating inference parameters. FIG. 6B is a diagram showing another example of a functional configuration for updating inference parameters. These configurations may be constructed using part of the configuration of the image processing device 10 in FIG. 2B, or may be constructed as a dedicated system for updating inference parameters.

Regarding FIG. 6A, in the update of the inference parameters, the HEVC encoding mode determined by the first encoding mode determination unit 101 for the input image, which is the encoding-target image, and the input image are input to the second encoding mode determination unit 104. The second encoding mode determination unit 104 uses the inference parameters set at that time and determines the encoding modes for both AV1 and VVC through inference that takes into account the HEVC encoding mode supplied for the input image. The determined encoding modes for AV1 and VVC are respectively output to a parameter update unit 601.

The input image is supplied to a reference unit 602, and the encoding modes for AV1 and VVC are determined. The reference unit 602 determines the encoding modes for AV1 and VVC for the input image by executing encoder software provided by respective standard organizations for AV1 and VVC. The output result from the reference unit 602 can be used as training data for the prediction mode determined by the NN intra prediction unit 203n in the second encoding mode determination unit 104.

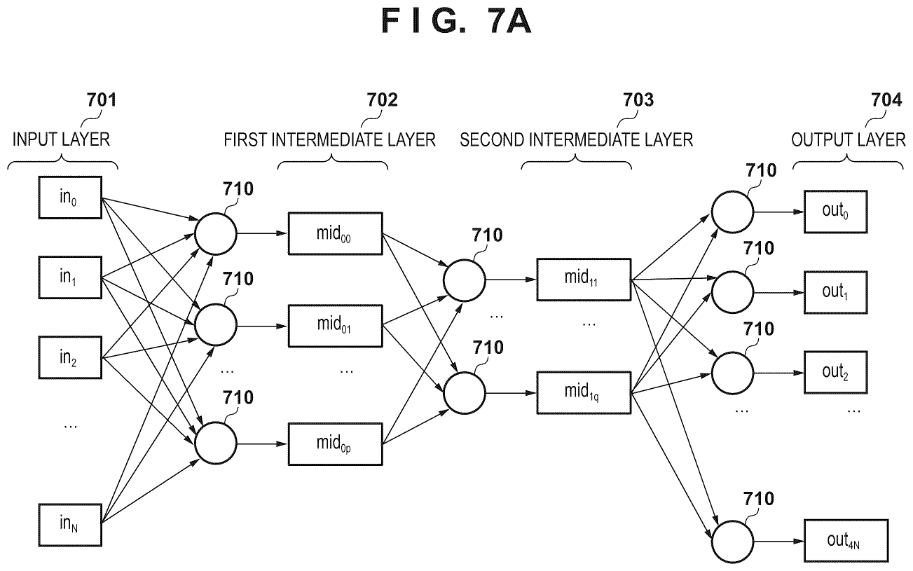

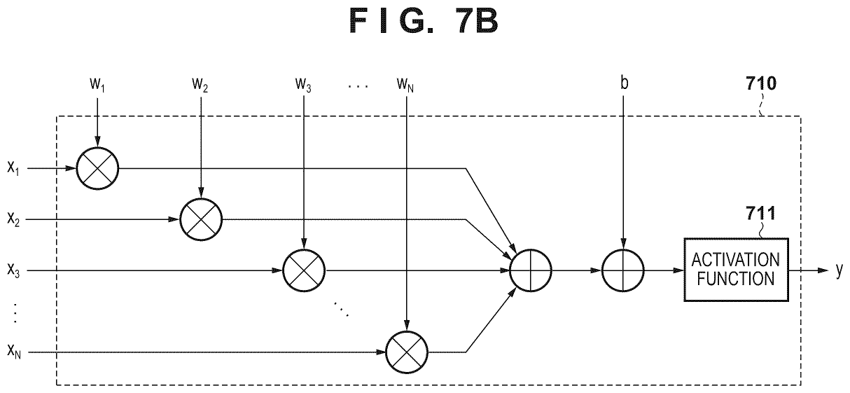

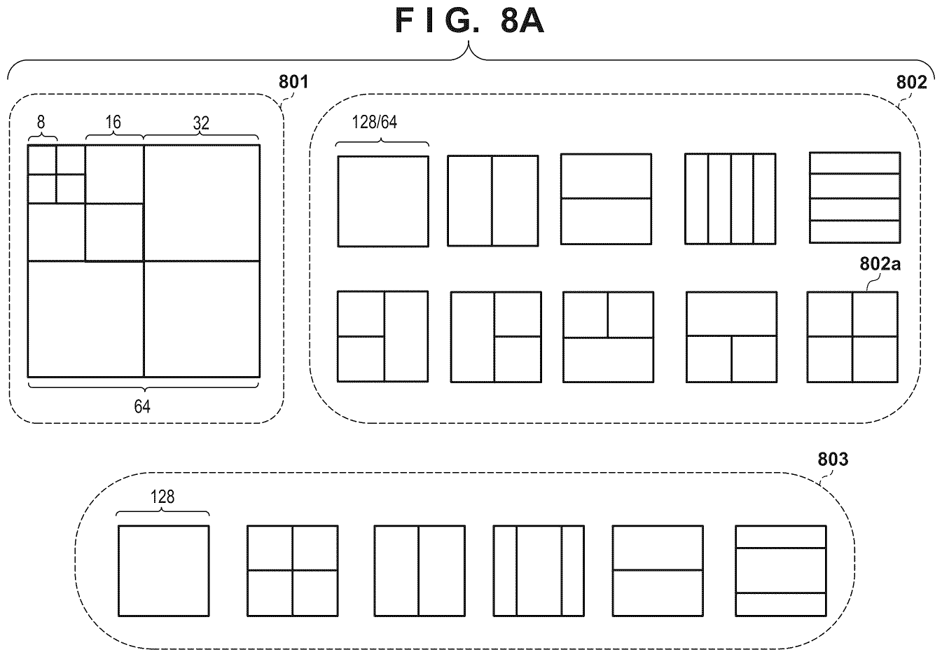

The parameter update unit 601 updates the inference parameters based on the encoding mode input from the second encoding mode determination unit 104 and the reference encoding mode input from the reference unit 602. The inference parameters may be weighting coefficients and bias values as shown in FIG. 7B. Details will be described later with reference to FIGS. 7A and 7B. The inference parameters updated by the parameter update unit 601 are fed back to the second encoding mode determination unit and are used when determining the encoding mode for the next input image.

Next, in FIG. 6B, similarly to FIG. 6A, first, the HEVC encoding mode determined for the encoding-target input image by the first encoding mode determination unit 101 and the input image are input to the second encoding mode determination unit 104. The second encoding mode determination unit 104 uses the inference parameters set at that time and determines the encoding modes for both AV1 and VVC through inference that takes into account the HEVC encoding mode supplied for the input image. The determined AV1 and VVC encoding modes are respectively output to the second encoding unit 105. In the configuration of FIG. 6B, the second encoding unit 105 performs encoding processing of AV1 and VVC in accordance with the determined encoding modes of AV1 and VVC, and outputs the results to the second encoded stream storage 106. The encoded data stored in the second encoded stream storage 106 is decoded in a second decoding unit 612, and the decoded image obtained through the decoding and information on the generated code amount of the encoded data are output to the parameter update unit 611.

The input image is supplied to the parameter update unit 611 as well, and the parameter update unit 611 updates the inference parameters such that the difference between the AV1 and VVC decoded images and the input image becomes smaller. In this case, Peak Signal to Noise Ratio (PSNR), Structural Similarity (SSIM), and the like are used as evaluation indices. In addition to the difference information, the inference parameters can be updated taking into consideration the generated code amount in the encoded data. For example, logic parameters can be updated to increase the value of Ei according to the following formula:

Ei=α×PSNR+β×(1/generated code amount) (α and β are desired coefficients)

The updated inference parameters are output to the second encoding mode determination unit 104 and are used when determining the encoding mode for the next input image.

By repeating the above processing, it becomes possible to set the inference parameters to more optimal values, and it becomes possible to determine the AV1 or VVC encoding mode by performing inference with high accuracy based on the HEVC encoding mode notified from the first encoding mode determination unit 101.

Next, a configuration example of the NN intra prediction unit 203n will be described with reference to FIGS. 7A and 7B. First, FIG. 7A is a diagram illustrating a configuration of a neural network (NN). As shown in FIG. 7A, the NN of this embodiment can have a four-layer structure including an input layer 701, a first intermediate layer 702, a second intermediate layer 703, and an output layer 704. Two successive layers are connected by one or more neurons 710. The output value of the previous layer is input to the neuron 710, and the output value obtained through the above-mentioned arithmetic processing is output to the subsequent layer. The NN intra prediction unit 203n can also have a configuration similar to that shown in FIG. 7A.

The number of pieces of data in0 to inN input to the input layer 701 matches the number of pieces of data out0 to outN output from the output layer 704. On the other hand, the number of pieces of data mid00 to mid0p in the first intermediate layer 702 and the number of pieces of data mid11 to mid1q in the second intermediate layer 703 do not need to match the number of pieces of data in the input layer 701 and the output layer 704. Accordingly, the number of neurons 710 connecting the two layers may be any number greater than or equal to one. The pieces of data in0 to inN input to the input layer 701 are, for example, an encoding mode, an input image, a reference image, and the like in HEVC, and the pieces of data out0 to outN output from the output layer 704 are the prediction mode for AV1 or VVC and the predicted image.

Next, FIG. 7B is a diagram illustrating the configuration of the neuron 710, which is the computational unit of the neural network shown in FIG. 7A. As shown in FIG. 7A, the NN of this embodiment can include a plurality of the neurons 710. The neuron 710 performs an operation on a plurality of input values x1 to xN using weights w1 to wN, a bias b, and an activation function, and outputs an output value y. The neuron 710 calculates a value x′ using weighting coefficients w1 to wN and a bias value b, for example, as shown in the following equation (1). The weighting coefficients w1 to wN and the bias value b correspond to the above-mentioned inference parameters, and are values that are variably determined through a predetermined learning process, and can take different values depending on the AV1 and VVC encoding schemes.

$$[ Math . 1 ]$$

$${x}^{′} = {\sum }_{n = 1}^{N} ( {x}_{n} \times {w}_{n} ) + b \qquad Equation ( 1 )$$

The neuron 710 then inputs the calculated value x′ into the activation function 711 to calculate the output y. The activation function 711 is a nonlinear function such as a sigmoid function or a Rectified Linear Unit (ReLU) function. When the value x′ is given to the sigmoid function, the output value y is calculated using the following equation (2).

$$[ Math . 2 ]$$

$$y = \frac{1}{1 + {e}^{- {x}^{′}}} \qquad Equation ( 2 )$$

When the value x′ is given to the ReLU function, the output value y is calculated using the following equation (3).

$$[ Math . 3 ]$$

$$y = \{ \begin{matrix}0 ( {x}^{′} \leq 0 ) \\ {x}^{′} ( {x}^{′} > 0 )\end{matrix} \qquad Equation ( 3 )$$

In the above description, an example of the configuration of the NN intra prediction unit 203n was described, but an NN block size determination unit 202n and an NN inter prediction unit 204n can also be configured in a similar manner in a case where block size and inter prediction block partition information are provided as the encoding mode. The circuit scale can be further reduced by sharing the block size determination unit 202 and the inter prediction unit 204 between the image processing devices for AV1 and VVC. Details will be described in the following embodiments.

According to the embodiment described above, in an image processing device that supports a plurality of encoding schemes, it is possible to determine an encoding mode for another encoding scheme by performing inference using a neural network based on an encoding mode determined for one encoding scheme, thereby making it possible to reduce the circuit scale of the other encoding scheme.

In the above embodiment, AV1 and VVC have been described as examples of the second encoding scheme, but the second encoding scheme is not limited to these. For example, it is also possible to include another encoding scheme in which the encoding mode determined in the first encoding scheme can be used.

### Second Embodiment

Next, a second embodiment will be described. The configuration of the image processing system in this embodiment is the same as that shown in FIG. 1A. The basic configuration of the image processing device 10 is also the same as that shown in FIG. 1B and FIG. 2A. Other changes corresponding to this embodiment will be described below as appropriate. This embodiment will describe processing in which the information on the first encoding mode determined by the first encoding mode determination unit 101 and provided to the second encoding mode determination unit 104 includes information on the block size.

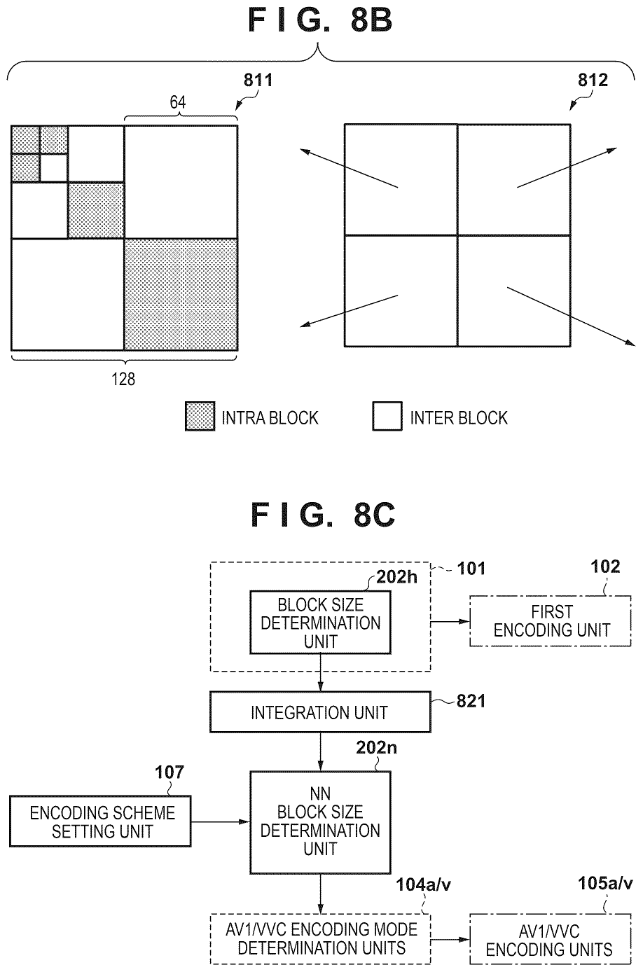

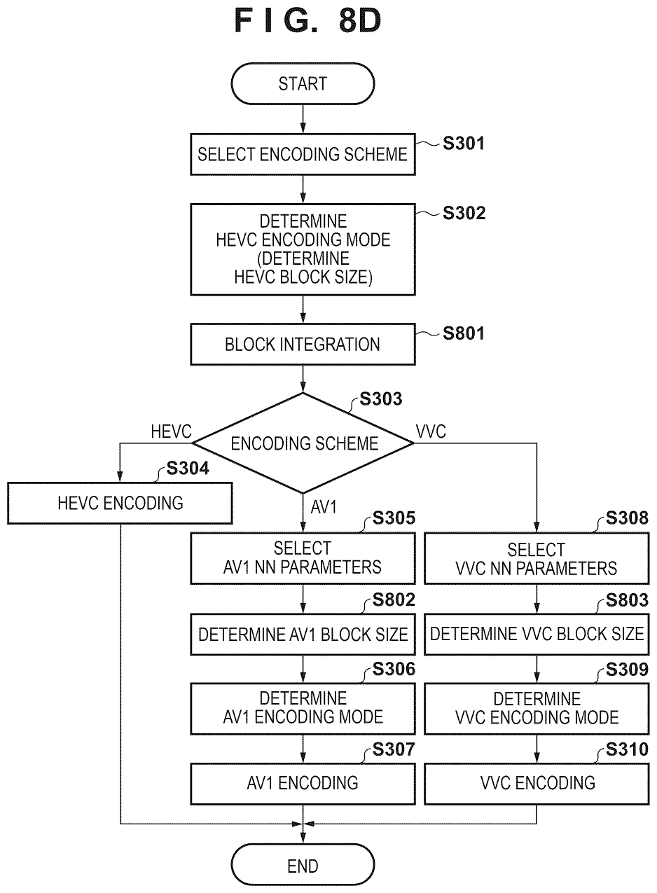

FIG. 8A is a diagram schematically illustrating block partition patterns used in the encoding schemes HEVC, AV1, and VVC. A partition pattern 801 indicates a block partition pattern (first block partition pattern) of HEVC, which is the first encoding scheme. Here, a 64×64-pixel block can be partitioned into 32×32, 16×16, and 8×8 based on a quadtree. On the other hand, the block partition pattern of the second encoding scheme (second block partition pattern) is different from the first block partition pattern. Specifically, partition patterns 802 indicate block partition patterns for AV1. Here, 10 different partition patterns are possible for 128×128 or 64×64-pixel blocks. In addition, in a pattern of partitioning into four squares shown as a partition pattern 802a, further division is possible. In AV1, block sizes can be selected from a minimum of 4×4 to a maximum of 128×128 pixels. Partition patterns 803 indicate block partition patterns for VVC. Here, six different partition patterns are possible for pixel blocks with a maximum CTU size of 128×128. In VVC, the block size can be selected from a minimum of 4×4 to a maximum of 128×128 pixels.

As described above, the encoding schemes for HEVC, AV1, and VVC have different block partition patterns, and the partition pattern in HEVC cannot be adopted as-is. However, by performing inference using a neural network with reference to the partition pattern in HEVC, it is possible to improve the efficiency of the processing when determining the partition patterns in AV1 and VVC.

In this embodiment, the partition patterns in HEVC are grouped into 128×128-size units, or in other words, four 64×64-pixel blocks are integrated and input to a block size determination unit 202n made into a neural network, to perform inference to determine the partition pattern in AV1 or VVC. FIG. 8B is a diagram showing an example in which the partition patterns in HEVC are integrated into 128×128 size units. In FIG. 8B, gray hatched regions indicate intra blocks, and white blocks indicate inter blocks. In addition, in a partition pattern 812, motion vectors set for each inter block are indicated by arrows.

As shown here, the prediction modes of the respective 64×64 blocks do not necessarily match. In addition, even if the prediction modes match, the directions of the motion vectors do not necessarily match. For example, a partition pattern 811 shows an example in which both intra blocks and inter blocks are present, and in such a state, the likelihood of blocks being merged is low even in AV1 and VVC. Also, as in the partition pattern 812, even if all blocks are inter blocks but the directions of the motion vectors do not match, the likelihood of blocks being merged in AV1 or VVC is low.

In this way, by referring to the partition pattern in HEVC and performing inference using a neural network, it is possible to skip unnecessary processing when determining the block partition pattern in AV1 or VVC, thereby improving processing efficiency and reducing power consumption.

Next, the flow of the block size determination processing in this embodiment will be described with reference to FIGS. 8C and 8D. FIG. 8C is a diagram showing an example of a schematic configuration of the image processing device 10 corresponding to this embodiment. FIG. 8D is a flowchart showing an example of processing corresponding to this embodiment. The flowchart in FIG. 8D is based on the flowchart in FIG. 3, with processing corresponding to this embodiment added. Steps that use the same reference signs as in FIG. 3 basically perform the same processing as described with reference to FIG. 3, and unless otherwise specified below, the description with reference to FIG. 3 applies correspondingly.

First, in step S301, an encoding scheme is selected, and in step S302, the first encoding mode determination unit 101 determines the encoding mode of HEVC. At this time, a block size determination unit 202h of the first encoding mode determination unit 101 determines the block size. Information on the determined HEVC block size is notified to an integration unit 821, and the blocks are integrated in step S801. Here, integration of blocks means processing for grouping four 64×64-pixel blocks together and converting them into a 128×128-pixel block, as described above. The integration unit 821 can hold information on at least two lines of pixel blocks in the HEVC block size. Information on the block size or the partition pattern for the 128×128-pixel block obtained through block integration is provided to the NN block size determination unit 202n.

In the flowchart of FIG. 8D, after the block aggregation in step S801, if the encoding scheme selected in step S301 is HEVC, the processing proceeds to step S304, where HEVC encoding is performed. If the selected encoding scheme is AV1, the processing proceeds to step S305, where inference parameters for AV1 are selected. The inference parameters selected here include the inference parameters for the NN block size determination unit 202n. In the subsequent step S802, the NN block size determination unit 202n performs processing for determining the AV1 block size based on the HEVC partition pattern of the processing-target pixel block provided by the integration unit 821, through inference using the selected AV1 inference parameters. At this time, the inference may be made based on the prediction modes (intra prediction mode and inter prediction mode) of each of the integrated 64×64-pixel blocks, and further based on information on motion vectors in the inter mode. When the block size is determined, the processing proceeds to step S306, where the AV1 encoding mode is determined in the same manner as described with reference to FIG. 3, and AV1 encoding is performed in step S307.

If the selected encoding scheme is VVC, the processing proceeds to step S308, where inference parameters for VVC are selected. The inference parameters selected here include the inference parameters for the NN block size determination unit 202n. In the subsequent step S803, the NN block size determination unit 202n performs processing for determining the VVC block size based on the HEVC partition pattern of the processing-target pixel blocks provided by the integration unit 821 through inference using the selected inference parameters for VVC. At this time, inference may be performed based on the prediction modes (intra prediction mode and inter prediction mode) of each of the integrated 64×64-pixel blocks, and further based on information on motion vectors in the inter mode. When the block size is determined, the processing proceeds to step S309, where the VVC encoding mode is determined in the same manner as described with reference to FIG. 3, and VVC encoding is performed in step S310.

The method for learning the inference parameters for the NN block size determination unit 202n can be implemented in the same manner as that described with reference to FIGS. 6A and 6B in the first embodiment. In this embodiment, the HEVC partition pattern determined by the first encoding mode determination unit 101 for the input image, which is the encoding-target image, the prediction modes (intra prediction mode and inter prediction mode) for each of the integrated 64×64-pixel blocks, information on motion vectors in the inter mode, the input image, which is the encoding-target image, and the like are input to the second encoding mode determination unit 104. In addition, the configuration example of the NN block size determination unit 202n can also be constituted, similarly to that described in the first embodiment, for example, by a four-layer structure having an input layer 701, a first intermediate layer 702, a second intermediate layer 703, and an output layer 704 as shown in FIG. 7A. In addition, as shown in FIG. 7B, neurons 710 between layers can be configured to perform computation on a plurality of input values x1 to xN using weights w1 to wN, a bias b, and an activation function to output an output value y.

According to the present embodiment described above, in an image processing device that supports a plurality of encoding schemes, by performing inference using a neural network based on an encoding block size determined in one encoding scheme, it is possible to simplify the processing for determining block sizes in other encoding schemes and reduce the circuit scale of the other encoding schemes.

### Third Embodiment

Next, a third embodiment will be described. The configuration of the image processing system in this embodiment is the same as that shown in FIG. 1A. The basic configuration of the image processing device 10 is also the same as that shown in FIG. 1B and FIG. 2A. Other changes corresponding to this embodiment will be described below as appropriate. This embodiment will describe processing performed when the information on the first encoding mode determined by the first encoding mode determination unit 101 and provided to the second encoding mode determination unit 104 includes information on motion vectors and block partitioning in inter prediction.

A mode called Geometric Partitioning Mode (GPM) has been added to VVC for inter prediction. GPM is one of the merge modes, and enables motion compensation partitioned along diagonal lines, which cannot be handled by normal block partition. A merge mode is a method in which motion vectors (MVs) of spatially and temporally adjacent encoded blocks are referenced and used as the MVs of a current block, and is an encoding tool defined by HEVC. In GPM, an index indicating a combination of angle and distance that represents the shape of the division, and two merge indices that derive the motion vectors of two regions A and B are designated.

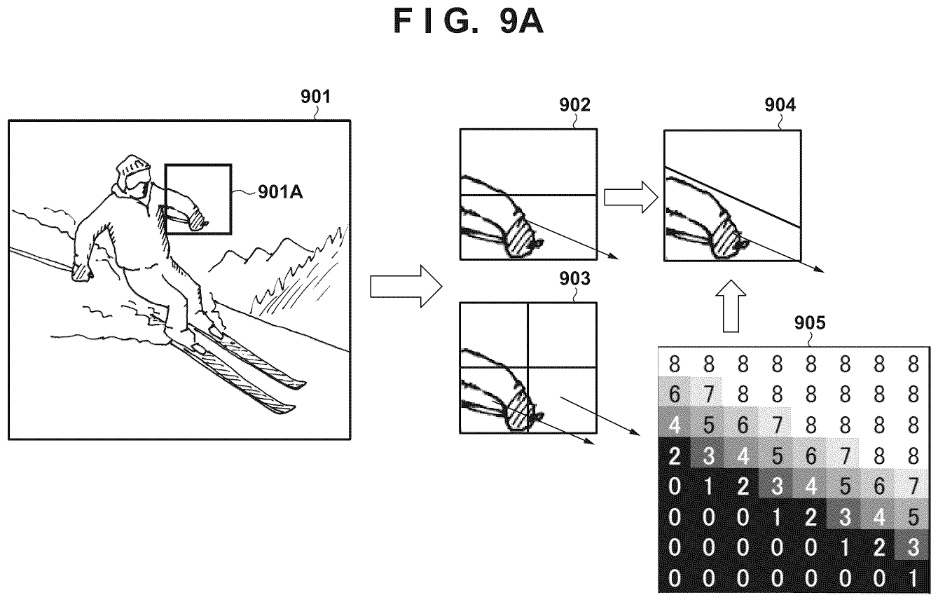

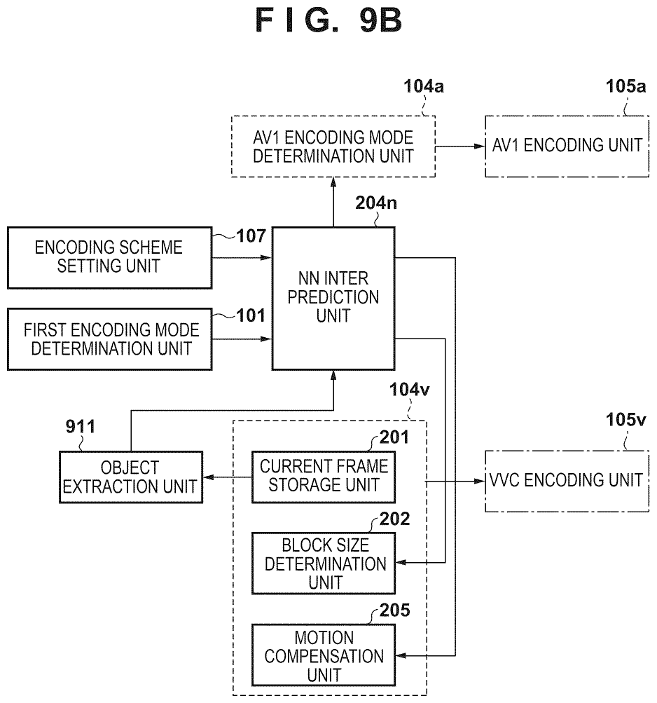

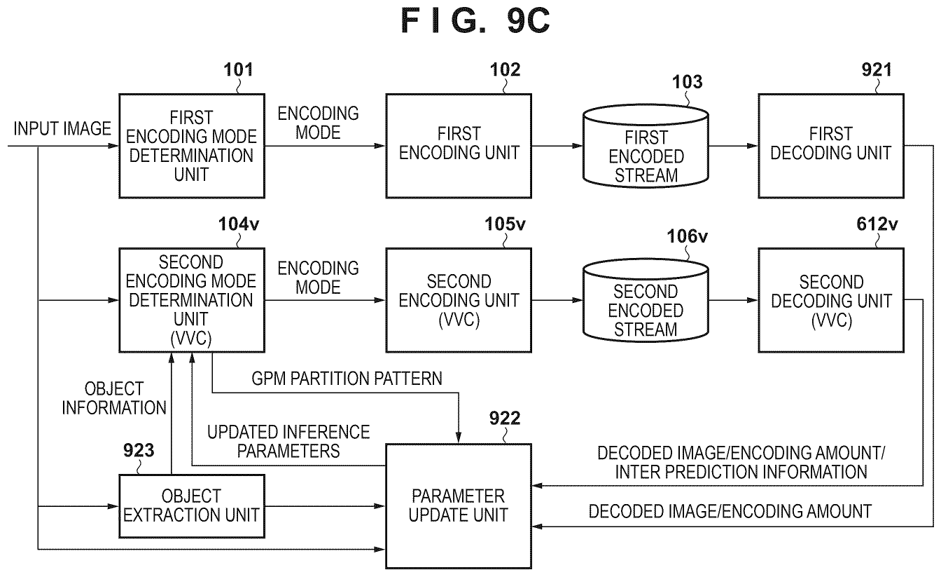

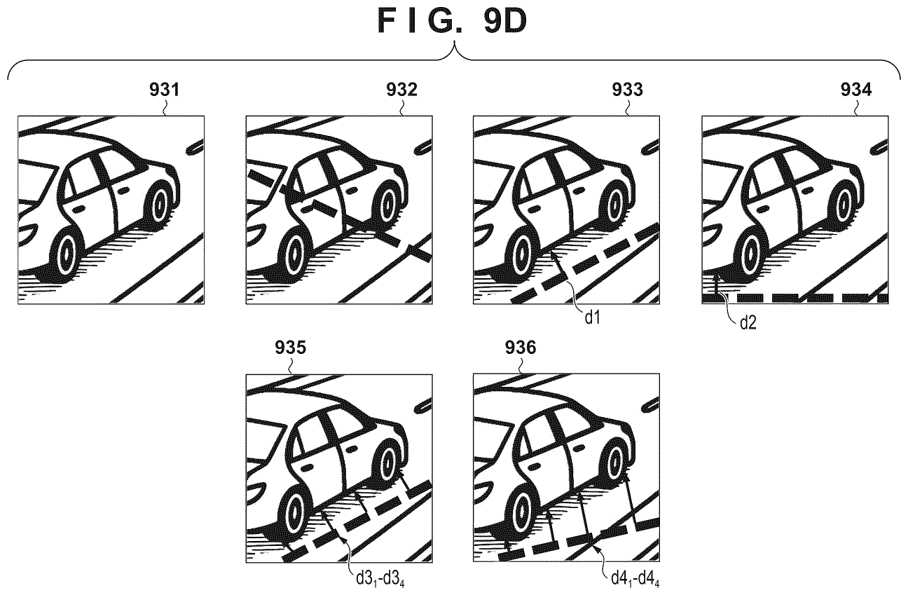

There are 64 block partition patterns (third block partition patterns) allowed in GPM, and in the case of 8×8 blocks, a table of 64 weighting coefficients is used. If the weighting coefficient is 8, a region A is selected, and if the weighting coefficient is 0, a region B is selected. In other cases, a weighted average of the motion-compensated predicted image of the region A and the motion-compensated predicted image of the region B is taken according to the weighting coefficient to generate the final predicted image. An example of the arrangement of weighting coefficients is shown in FIG. 9A.

By using GPM, more flexible PU partitioning than conventional rectangular partitioning becomes possible, and encoding efficiency can be improved by performing inter prediction that takes object shape into consideration. However, since there are 64 partition patterns in GPM, estimating the encoding distortion for each one imposes a heavy processing load and increases the circuit scale therefor. In view of this, in this embodiment, by referring to information on the motion vectors and block partitioning determined by the first encoding mode determination unit 101 and performing inference using a neural network, it is possible to improve processing efficiency and reduce the circuit scale.

FIG. 9A is a diagram for describing a comparison between a block partition scheme in a conventional encoding scheme (e.g., HEVC) and a block partition scheme in VVC. In the case of encoding a block 901A in an image 901, when encoding using HEVC, the partition pattern will be in accordance with the first block partition pattern, as in an image 902 or an image 903. The image 902 is partitioned into two parts, namely a top part and a bottom part, and the image 903 is partitioned into four square parts. However, an object included in the block 901A straddles a plurality of partition blocks in both partition patterns of the image 902 and the image 903, which results in poor encoding efficiency. In contrast, an image 904 shows an example in which one of the third block partition patterns of the GPM mode in VVC is applied, but in this case, the block 901A is partitioned diagonally, and therefore the object can be included in a single partition block without being arranged straddling a plurality of partition blocks. Weighting coefficients 905 show a table of weighting coefficients corresponding to the partition pattern applied to the image 904. The weighting coefficients range from 0 to 8. The final predicted image is generated by taking a weighted average of the motion-compensated predicted image of the region A and the motion-compensated predicted image of the region B according to the weighting coefficients.

In this way, in VVC, it is possible to set a third block partition pattern of the GPM mode that matches the shape of the object that could not be fully handled by the conventional encoding scheme. However, since the object straddles a plurality of blocks even in the first block partition pattern in the conventional scheme, it is possible to narrow down the candidates from among the 64 third block partition patterns of VVC by using information on this partition pattern. In addition, by performing inference using a neural network based on the first block partition pattern, it is possible to more efficiently specify the third block partition pattern. In addition, by taking into consideration the motion vectors extracted using the conventional method, it is possible to more efficiently calculate the motion vectors in the third block partition pattern as well through inference using a neural network.

Next, a configuration using a neural network according to this embodiment will be described with reference to FIG. 9B. FIG. 9B is a diagram showing an example of a schematic configuration of the image processing device 10 corresponding to this embodiment. In FIG. 9B, the motion detection unit is separated from the inter prediction unit 204 and left in the same position on the VVC encoding mode determination unit 104v side, and is implemented as a neural network and disposed outside the encoding mode determination unit 104v as an NN inter prediction unit 204n. The NN inter prediction unit 204n has the same configuration as the AV1 encoding mode determination unit 104a, and the configuration on the encoding mode determination unit 104a side is also the same.

In addition, the object extraction unit 911 extracts an object from the current frame stored in the current frame storage unit 201 in the VVC encoding mode determination unit 104v, and outputs the object to the NN inter prediction unit 204n. The NN inter prediction unit 204n takes into consideration the object information and determines inter prediction parameters such as motion vectors and the third block partition pattern of the GPM mode, based on the information on the encoding mode, particularly the information on the first block partition pattern, provided by the first encoding mode determination unit 101. The determined motion vector is provided to the motion compensation unit 205, and the third block partition pattern is provided to the block size determination unit 202. When inter prediction is performed, the block size determination unit 202 determines the block size based on the information on the third block partition pattern from the NN inter prediction unit 204n.

An example of the configuration of the NN inter prediction unit 204n can also be constituted by, for example, a four-layer structure having an input layer 701, a first intermediate layer 702, a second intermediate layer 703, and an output layer 704 as shown in FIG. 7A, similarly to that described in the first embodiment. In addition, as shown in FIG. 7B, neurons 710 between layers can be configured to perform computation on a plurality of input values x1 to xN using weights w1 to wN, a bias b, and an activation function to output an output value y. The method for learning the inference parameters for the NN inter prediction unit 204n can be implemented in the same manner as that described with reference to FIGS. 6A and 6B in the first embodiment. Alternatively, learning can be performed using the method shown in FIG. 9C, for example.

Hereinafter, a method for learning inference parameters according to this embodiment will be described with reference to FIG. 9C. In FIG. 9C, an input image is input to the first encoding mode determination unit 101, a first encoding mode is determined, encoding is performed in the first encoding unit using the first encoding scheme in the determined encoding mode, and the generated first encoded stream is stored in the first encoded stream storage 103. The stream is decoded by a first decoding unit 921, and information on the decoded image resulting from the decoding and the code amount of the encoded data is provided to a parameter update unit 922.

The input image is input also to the second encoding mode determination unit (here, the encoding mode determination unit for VVC) 104v, and the VVC encoding mode including the third block partition patterns is determined using the inference parameters set at that time and taking into consideration the information on the first block partition patterns provided from the first encoding mode determination unit for the input image and the object information provided from the object extraction unit. Here, the object extraction unit 923 extracts information about the object from the input image and provides it to the second encoding mode determination unit 104v. The object information can be information on the region where the object is located, information on the shape of the object, or an object image.

The encoding mode determined by the second encoding mode determination unit 104v is notified to the second encoding unit 105v, which then performs encoding using the second encoding scheme (here, VVC), and the resulting second encoded stream is stored in the second encoded stream storage 106v. The encoded data stored in the second encoded stream storage 106v is decoded in the second decoding unit 612v, and the decoded image obtained through the decoding and information on the code amount of the encoded data are output to the parameter update unit 922.

The input image and the object information extracted by the object extraction unit 923 are supplied also to the parameter update unit 922, and the parameter update unit 922 updates the inference parameters so as to reduce the difference between the VVC decoded image and the input image. In this case, Peak Signal to Noise Ratio (PSNR) and Structural Similarity (SSIM) can be used as evaluation indices. The updated inference parameters are output to the second encoding mode determination unit 104v and are used when determining the encoding mode for the next input image.

As a loss function during neural network training, for example, the following equation 4 can be set and training can be performed such that f(x) becomes small.

$$f ( x ) = “ Distortion of VVC codec ( Dv ) ” / ” distortion of conventional codec ( Dh ) ” + “ penalty ( Pn ) ” \qquad Equation ( 4 )$$

In equation 4, Dv and Dh can be calculated based on the difference between the input image and the decoded image. The penalty Pn can be considered as follows, for example.

The value of the penalty Pn can be set based on whether or not to the object is to be partitioned in GPM partitioning of the NN output, for example. Specifically, the value of the penalty Pn when the object is partitioned in GPM partitioning is set to W0, and the value of the penalty Pn when the object is not partitioned is set to W1=α×D. In this case, D is a value obtained by normalizing the distance in the range of 0 to 1, and W0 is set to a value that is much larger than the value of α when D=1 (W0>>W1 (=α×1)).

An example of the concept of distance will be described with reference to FIG. 9D. FIG. 9D is a diagram for describing the relationship between the outline of an object and the block partition boundary. In FIG. 9D, the processing-target block is an image 931. Here, an automobile is shown as an object. In contrast, an image 932 shows a state in which the object is partitioned in GPM division. The dotted line across the image 932 indicates the partition boundary in the GPM partition pattern. In such a state, the value of the penalty Pn is set to W0 to increase the penalty, and learning is performed such that this partition pattern is not adopted.

In addition, as shown in images 933 and 934, even if the shortest distances d1 and d2 between the outline of the object and the partition boundary are both the same distance (d1=d2), the value of Dv will be different. That is, when the partition boundary extends along the object as in the image 933, the value of the distortion Dv is smaller, and the value of f(x) is smaller for the image 933. Thus, learning is performed such that a partition boundary that is closer to the outline of the object is selected.

In addition, the distance between the object and the GPM partition boundary may be calculated as the shortest distance, or alternatively, a plurality of distances between the object and the GPM partition boundary may be calculated and the average or median value thereof may be used as the distance for the loss function f(x). For example, an image 935 and an image 936 have different distances of the GPM partition boundary to the contour line of the object. In the case of the image 935, as an example, distances d3₁ to d3₄ are measured, and the average value thereof is smaller than the average value of distances d4₁ to d4₄ in the image 936. Accordingly, the value of the loss function f(x) becomes smaller with the GPM partitioning of the image 935.

In addition, learning may be performed such that an error between a motion vector MVc of a processing-target block and a motion vector MVa of a neighboring block falls within an allowable range. Specifically, if R1<T holds true, where R1 is the prediction error of HEVC, R2 is the prediction error of the VVC reference, and T is the prediction error using the NN output GPM in the case where the signs of the vector elements of MVc and MVa are the same, a penalty W₀ is applied to perform learning. In addition, a penalty W2=α×(T−R2) may be further applied to take into account the degree of deviation between T and R2 during learning. This enables learning to avoid cases where the prediction error when using GPM is worse than the prediction error of HEVC, and makes it possible to approach the VVC reference through learning. In addition, if adjacent blocks (e.g., the two on the left and top) are input and the processing-target block and the adjacent block have the same object, a penalty that is based on the distance between a partition boundary position of the neighboring block at the boundary between the adjacent block and the processing-target block and the GPM partition boundary position of the processing-target block can also be taken into account.

In this manner, by increasing the penalty when the partition boundary of a block in the GPM division intersects with an object and partitions the object, or when the distance between the object and the partition boundary is far, the system can learn to bring the object and the partition boundary of the GPM division closer together.

According to the present embodiment described above, when using GPM, which is newly adopted in VVC inter prediction, the processing load of GPM division can be reduced by performing inference using a neural network based on information on block sizes and motion vectors determined in conventional encoding schemes. This simplifies processing for determining the block size and motion vectors in the VVC encoding method, and makes it possible to reduce the circuit scale.

### Fourth Embodiment

Next, a fourth embodiment will be described. The configuration of the image processing system in this embodiment is the same as that shown in FIG. 1A. The basic configuration of the image processing device 10 is also the same as that shown in FIG. 1B and FIG. 2A. Other changes corresponding to this embodiment will be described below as appropriate. This embodiment will describe processing in the case where an intra prediction mode is included as information on the first encoding mode determined by the first encoding mode determination unit 101 and provided to the second encoding mode determination unit 104.

Compared to conventional encoding schemes such as HEVC, a new intra prediction mode that generates predicted pixels for the color difference signal from the decoded luminance signal has been added in AV1 and VVC. In AV1, Chroma from Luma (CfL) is added, and in VVC, Cross-Component Linear Model Prediction (CCLM) is added. By adopting CfL and CCLM technologies, it is expected that encoding efficiency will improve in complex texture regions including vivid colors that are difficult to predict using angular prediction, DC prediction, and planar prediction.

CfL and CCLM use a method of estimating color difference from luminance, which makes it possible to reduce the amount of data to be stored. Specifically, depending on the image, color difference information (Cb(U), Cr(V)) may have a relationship with luminance information (Luma(Y)) that is linear to a certain degree. In addition, depending on the subject, edges included in the luminance information and color difference information may be at the same location, and a correlation may be observed between them.

However, when using this tool, the prediction result of the luminance signal is used to predict the color difference signal. Specifically, in order to generate a locally decoded luminance pixel value, luminance signals in the surrounding area of the target color difference signal are added, then downsampled, and further weighted to generate a predicted pixel. In this case, the weighting coefficients can be determined using the least squares method. This method is difficult to parallelize and results in a large circuit scale. In view of this, in this embodiment, a configuration is proposed that can reduce the circuit scale while reducing the load of parallelization.

In intra prediction mode, if angular prediction is not adopted, there is a high likelihood that prediction cannot be performed from surrounding pixels, resulting in reduced efficiency. However, DC prediction and planar prediction are more efficient than CfL and CCLM in some cases, and therefore can be used as one of the judgment criteria. For example, in a case where there is luminance variation within a block but color difference is uniform, there is an advantage to using the intra prediction mode.

In addition, CCLM has three modes corresponding to the prediction directions: an INTRA_L_CCLM mode that refers to the left direction, an INTRA_LT_CCLM mode that refers to the left direction and the upward direction, and an INTRA_T_CCLM mode that refers to the upward direction. The weight calculation method is switched depending on the selected mode. For example, if the intra prediction mode of HEVC refers to the adjacent block on the left, there is a high likelihood that the INTRA_L_CCLM mode will be selected in CCLM as well. Accordingly, inputting the intra prediction mode makes it possible to select the CCLM mode more efficiently. On the other hand, by executing inference using an NN, it is possible to avoid CCLM narrowing down the mode candidates to only INTRA_L_CCLM.

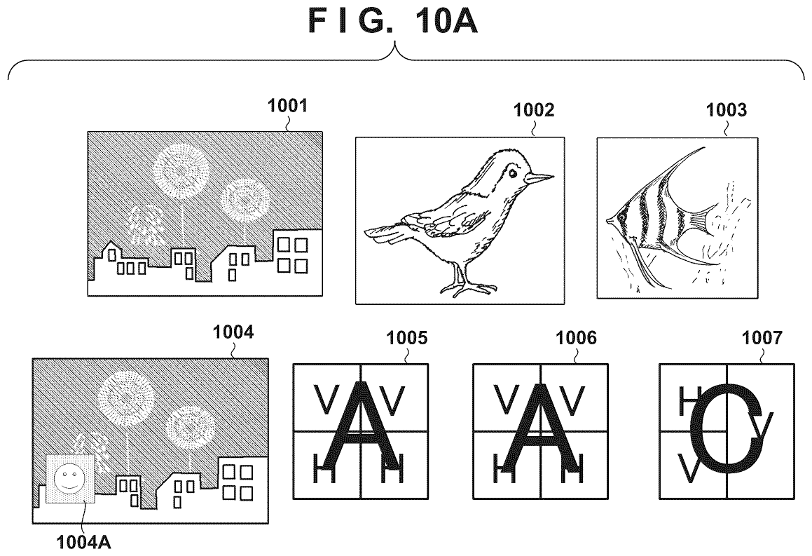

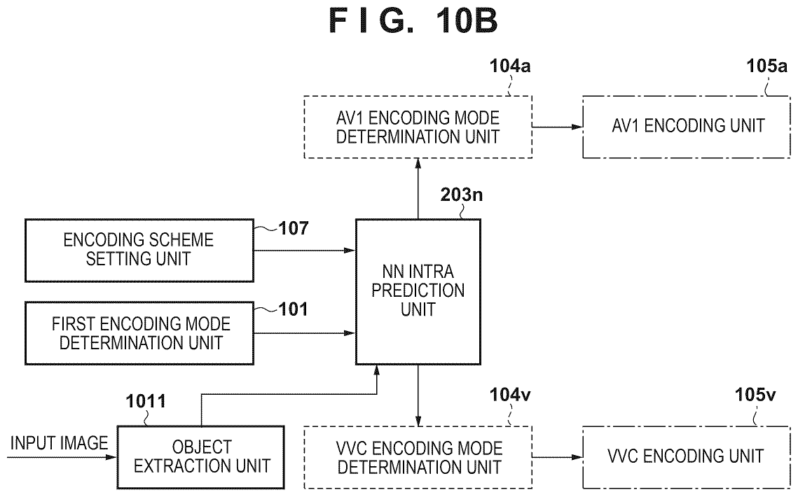

The object information also includes edge detection results, flatness detection results, and object detection results (detection of the object itself in the image, and information on the type of object (person, animal, branch, sky, wall, etc.)). This information can be used to determine “regions with high color saturation (including vivid colors) and a high number of high-frequency components (e.g., complex textures)”, where CfL and CCLM are most effective. For example, as shown in FIG. 10A, an image 1001 of a fireworks display, an image 1002 of a bird, and an image 1003 of tropical fish have many edge components and therefore many high-frequency components, and are highly saturated, resulting in rich and vivid colors, making them suitable for CfL and CCLM.

In view of this, in this embodiment, the encoding mode (intra prediction mode) determined in HEVC or the like and object information are provided to a neural network, and conversion to an appropriate encoding mode (color difference intra prediction mode) in AV1 or VVC is performed. By inputting the intra prediction mode determined in a conventional method such as HEVC and object information into a neural network and performing inference, the likelihood of determining an appropriate prediction mode can be increased.

Next, the configuration of the image processing device 10 corresponding to this embodiment will be described with reference to FIG. 10B. FIG. 10B is similar to the diagram shown in FIG. 2B, but differs in that it includes an object extraction unit 1011 that extracts object information from an input image. The object extraction unit 1011 extracts edge detection results, flatness detection results, and object detection results (detection of the object itself in the image, and information on the type of object (person, branch, sky, wall, etc.)) as object information from the input image. The extracted object information is supplied to the NN intra prediction unit 203n.

As a result, the NN intra prediction unit 203n performs intra prediction based on the information on the prediction mode of intra prediction in the first encoding mode determination unit 101 supplied from the first encoding mode determination unit 101, the encoding-target image, and the object information from the object extraction unit 1011, and can set CfL as the encoding mode for intra prediction when AV1 is designated in the encoding scheme setting unit, or CCLM when VVC is designated. For example, if the processing-target block is a complex texture region with high color saturation based on the edge detection result and flatness detection result as object information, CfL or CCLM is set. The other configurations in FIG. 10B are the same as those already described with reference to FIG. 2B, and therefore description thereof will be omitted here.

By adopting the configuration of FIG. 10B, the intra prediction unit 203 is removed from the AV1 encoding mode determination unit 104a and the VVC encoding mode determination unit 104v and shared, thereby making it possible to reduce the circuit scale.

In addition, regarding the learning method of the NN intra prediction unit 203n, it is possible to employ the configurations of FIGS. 6A and 6B. However, a configuration equivalent to the object extraction unit 1011 in FIG. 10B that extracts and provides object information from an input image is added to the second encoding mode determination unit 104. The second encoding mode determination unit 104 determines the encoding mode for both AV1 and VVC, taking into consideration the HEVC encoding mode and object information supplied for the input image, using the inference parameters set at that time. The determined encoding modes for AV1 and VVC are respectively output to the parameter update unit 601. Other operations are the same as those described in relation to FIGS. 6A and 6B. The neural network configuration of the NN intra prediction unit 203n is also the same as that described in relation to FIGS. 7A and 7B.

According to the present embodiment described above, when using CfL added to AV1 and CCLM added to VVC in intra prediction mode, inference using a neural network based on information on the intra prediction mode in conventional encoding schemes and object information extracted from the input image is executed, making it possible to efficiently determine whether to select CfL or CCLM. This simplifies the processing for determining the intra prediction mode in the AV1 and VVC encoding formats, and makes it possible to reduce the circuit scale.

### Fifth Embodiment

Next, a fifth embodiment will be described. The configuration of the image processing system in this embodiment is the same as that shown in FIG. 1A. The basic configuration of the image processing device 10 is also the same as that shown in FIG. 1B and FIG. 2A. Other changes corresponding to this embodiment will be described below as appropriate. This embodiment will describe processing in the case where an intra prediction mode is included as information on the first encoding mode determined by the first encoding mode determination unit 101 and provided to the second encoding mode determination unit 104.

Compared to conventional encoding schemes such as HEVC, AV1 and VVC have expanded encoding tools for screen content (CG: computer graphics). Specifically, it is now possible to use Intra Block Copy (IBC), which uses an already encoded part of the same frame as a predicted image for screen content, and a palette mode, which uses a smaller number of colors. Here, the screen content includes a CG image that is superimposed on a live-action image, a CG background image that is superimposed on a live-action image, and the like. In AV1, both IBC and the palette mode are available, and IBC is available in VVC as well. For example, an image such as an image 1004 in FIG. 10A, in which a CG image 1004A is superimposed on an image 1001, which is a landscape image of fireworks, corresponds to this image.

IBC is a special intra prediction mode in which a predicted image is generated for luminance and chrominance blocks by copying a reference image in units of blocks from the processed surrounding region of the same encoding target image as the processing-target block. For example, high encoding efficiency can be achieved for a graphic image in which a similar texture pattern is repeated. IBC can be used for CU sizes ranging from 4×4 to 64×64, and the reference image is determined by designating a block vector (BV) in units of CUs.

Palette mode is an intra prediction tool that enables designation of 2 to 8 colors, and enables designation of the region and the index within a picture. For example, in the case of three colors, a table is created by assigning 0, 1, and 2 as indices in order starting from the color with the highest occurrence probability, and the color value of each index is designated using a palette. In this way, in the palette mode, pixel values can be replaced with indices when performing encoding, making it possible to reduce the amount of information.

In this embodiment, an example will be described in which a neural network is used to perform conversion to an intra block copy mode in AV1 or VVC by utilizing information on the encoding mode in HEVC and object information.

For example, in the encoding mode determined in HEVC, if the block size or block prediction mode is the same between two blocks, or more specifically, if they match or are similar, the IBC mode is more likely to be selected. On the other hand, if the block sizes or block prediction modes do not match between the two blocks, there is a high likelihood that a mode other than the IBC mode will be selected. Specifically, as shown in FIG. 10A, an image 1005 is an image of the letter “A”, and this image 1005 is partitioned into four blocks, with the upper side predicted in a vertical direction and the lower side predicted in a horizontal direction. In contrast, an image 1006 is also an image of the letter “A”, and the block partition pattern and prediction direction of each block are the same. On the other hand, an image 1007 is an image of the letter “C”, and the left half is partitioned into 4×4-pixel blocks, but the right half is partitioned into 8×4-pixel blocks. Also, on the left side, the top is predicted in the horizontal direction and the bottom is predicted in the vertical direction, and the right side is predicted in the vertical direction. In this way, the image 1007 does not match the image 1005 in either the block partition pattern or the prediction directions. Although an example of one character has been described in FIG. 10A, processing can be similarly performed also in the case where a plurality of characters are set as a unit.

In addition, based on the CG/natural image determination results, texture (repeating patterns, text) detection results, and solid area (flat area or low frequency area) detection results in the object information, it is possible to determine whether or not the object is a CG area that IBC mode excels at.

In addition, for example, in the encoding mode determined in HEVC, if the block size is small, the overhead of header information is large, and the palette mode is less likely to be selected. On the other hand, blocks with a large block size are more likely to be flat areas, and the palette mode is more likely to be selected. As with the IBC mode described above, object information can also be used to determine whether an object is a monochromatic block, which palette mode excels at, based on the CG/natural image determination results and the detection results of solid areas (flat areas or low frequency regions). In this embodiment, these are used for learning.

The configuration of the image processing device 10 corresponding to this embodiment is the same as that shown in FIG. 10B. In the configuration of FIG. 10B, the NN intra prediction unit 203n performs intra prediction based on information on the prediction mode of intra prediction in the first encoding mode determination unit 101 and the encoding-target image, which are supplied from the first encoding mode determination unit 101, and object information from the object extraction unit 1011, and can set IBC or palette mode as the encoding mode for intra prediction when AV1 is designated in the encoding scheme setting unit, or IBC when VVC is designated. For example, if a texture with a repeating pattern is detected as object information, IBC is set. However, in the case of the AV1 palette mode, intra prediction is performed based only on block size information and object information, without using prediction mode information. The other configuration in FIG. 10B is the same as that already described with reference to FIG. 10B and FIG. 2B, and therefore the description will be omitted here.

The learning method of the NN intra prediction unit 203n according to this embodiment is also the same as that described in the fourth embodiment. Here as well, a configuration equivalent to the object extraction unit 1011 can be added to the configurations of FIGS. 6A and 6B. However, in the case of the AV1 palette mode, learning is performed regarding a case where the palette mode is selected based only on the block size information and object information, without using the prediction mode information. Other operations are the same as those described in the fourth embodiment. The neural network configuration of the NN intra prediction unit 203n is also the same as that described in relation to FIGS. 7A and 7B.

According to the present embodiment described above, when using IBC added to AV1, palette mode, and IBC added to VVC in intra prediction mode, IBC and palette mode can be used efficiently based on information on the intra prediction mode in an image processing device compatible with conventional encoding schemes and object information extracted from an input image. This simplifies the processing for determining the intra prediction mode in the AV1 and VVC encoding formats, and reduces the circuit scale. In addition, according to the present disclosure, it is possible to provide a technique that enables reduction of the circuit scale when making an image processing device compatible with a plurality of encoding schemes.

### Other Embodiments

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-210770, filed Dec. 3, 2024, which is hereby incorporated by reference herein in its entirety.

What is claimed is:

1. An image processing device comprising:
an encoding mode determination unit configured to determine, based on information on a first encoding mode in a first encoding scheme for an encoding-target image, a second encoding mode in a second encoding scheme different from the first encoding scheme through inference using a neural network, for the encoding-target image; and
an encoding unit configured to encode the encoding-target image using the second encoding mode.

2. The image processing device according to claim 1,
wherein the second encoding scheme includes at least two encoding schemes, and
the encoding mode determination unit determines the second encoding mode through the inference using an inference parameter learned for a predetermined input image in a designated encoding scheme among the at least two encoding schemes.

3. The image processing device according to claim 2,
wherein if information on a first intra prediction mode in the first encoding scheme is included in the information on the first encoding mode, the determining of the second encoding mode through the inference includes determining a second intra prediction mode in the second encoding mode.

4. The image processing device according to claim 3,
wherein the determining of the second intra prediction mode includes determining, based on a first prediction direction included in the information on the first intra prediction mode, a second prediction direction in the second intra prediction mode.

5. The image processing device according to claim 2, further comprising
an integration unit configured to integrate the information on the first encoding mode of a plurality of blocks having a first block size in the first encoding scheme, to generate the information on the first encoding mode of a second block size different from the first block size for the second encoding scheme,
wherein if the information on the first encoding mode includes information on a first block partition pattern for the first encoding scheme, the determining of the second encoding mode through the inference includes determining a second block partition pattern for the second encoding scheme based on the information on the first block partition pattern of the second block size generated by the integration unit.

6. The image processing device according to claim 5,
wherein the first block size is a block size of 64×64, and the second block size is a block size of 128×128, and
the integration unit integrates the information on the first block partition pattern of four blocks in the first encoding scheme to generate the information on the first block partition pattern of the second block size.

7. The image processing device according to claim 2, wherein
in a case where a first block partition pattern is allowed in inter prediction in the first encoding scheme, and a second block partition pattern different from the first block partition pattern is allowed in inter prediction in the second encoding scheme, wherein the second block partition pattern including third block partition patterns that partition a block diagonally,
the information on the first encoding mode includes the information on the first block partition pattern for the first encoding scheme, and
the determining of the second encoding mode through the inference includes selecting one of the third block partition patterns based on the first block partition pattern.

8. The image processing device according to claim 7, further comprising
an object extraction unit configured to extract information on an object included in the encoding-target image,
wherein the determining of the second encoding mode through the inference includes selecting one of the third block partition patterns further based on the information on the object.

9. The image processing device according to claim 8,
wherein the selecting of one of the third block partition patterns includes selecting a pattern that does not partition an image of the object included in a block to be partitioned.

10. The image processing device according to claim 9,
wherein the selecting of a pattern that does not partition the image of the object included in the block to be partitioned includes selecting a pattern in which a distance between an outline of the object and a partition boundary in the third block partition pattern is closer than in other patterns.

11. The image processing device according to claim 9,
wherein the selecting of a pattern that does not partition the image of the object included in the block to be partitioned includes selecting a pattern in which a partition boundary in the third block partition pattern extends along an outline of the object.

12. The image processing device according to claim 7,
wherein the information on the first encoding mode further includes information on a motion vector of a block partitioned in the first block partition pattern, and
the determining of the second encoding mode through the inference includes determining, based on the information on the motion vector, information on a motion vector in the selected third block partition pattern.

13. The image processing device according to claim 2, further comprising
an object extraction unit configured to extract information on an object from the encoding-target image, and
the determining of the second encoding mode through the inference includes determining a third intra prediction mode of the second encoding mode based on information on an intra prediction mode in the first encoding scheme and the extracted information on the object.

14. The image processing device according to claim 13,
wherein the third intra prediction mode includes a first prediction mode in which a predicted pixel of a color difference signal is generated from a decoded luminance signal of the same block, and
selection of the first prediction mode is based on an amount of edge components and a level of color saturation in the information on the object.

15. The image processing device according to claim 13,
wherein the third intra prediction mode includes a second prediction mode in which an image that has already been encoded using the second encoding method is used as a predicted image for the same encoding-target image, and
selection of the second prediction mode is based on information on the block size in the information on the first encoding mode and commonality of the prediction mode between blocks.

16. The image processing device according to claim 15,
wherein selection of the second prediction mode is further based on whether the object is a CG image.

17. The image processing device according to claim 13,
wherein the third intra prediction mode includes a third prediction mode including designation of an index of a color included in the encoding-target image, and
selection of the third prediction mode is based on a magnitude of the block size in the information on the first encoding mode and whether the object is monochrome.

18. The image processing device according to claim 1,
wherein the first encoding scheme is H.264 or HEVC, and the second encoding scheme is AV1 or VVC.

19. The image processing device according to claim 18, further comprising:
a first encoding mode determination unit configured to determine the first encoding mode in the first encoding scheme; and
a first encoding unit configured to encode the encoding-target image using the first encoding mode,
wherein if encoding using the second encoding scheme is designated, the first encoding mode is determined by the first encoding mode determination unit, and encoding by the first encoding unit is not performed.

20. The image processing device according to claim 1,
wherein the inference using the neural network is performed using at least the encoding-target image.

21. An image capture device comprising:
an image capture unit; and
an image processing device including:
an encoding mode determination unit configured to determine, based on information on a first encoding mode in a first encoding scheme for an encoding-target image, a second encoding mode in a second encoding scheme different from the first encoding scheme through inference using a neural network, for the encoding-target image; and
an encoding unit configured to encode the encoding-target image using the second encoding mode.

22. A control method for an image processing device, comprising:
determining, based on information on a first encoding mode in a first encoding scheme for an encoding-target image, a second encoding mode in a second encoding scheme different from the first encoding scheme through inference using a neural network, for the encoding-target image; and
encoding the encoding-target image using the second encoding mode.

23. A non-transitory computer-readable storage medium storing a computer program comprising instructions which, when the program is executed by a computer, cause the computer to carry out the method comprising:
determining, based on information on a first encoding mode in a first encoding scheme for an encoding-target image, a second encoding mode in a second encoding scheme different from the first encoding scheme through inference using a neural network, for the encoding-target image; and
encoding the encoding-target image using the second encoding mode.
